(19) United States
(12) Patent Application Publication
(10) Pub. No.: US 2011/0267806 A1
(43) Pub. Date: Nov. 3, 2011

(54) LUMINOUS DECORATION STRIP

(75) Inventors: HSIN-CHIN CHEN, TAINAN (TW); CHI-WEN GUO, TAINAN (TW); HSIN-HSING WU, KAOHSIUNG (TW); YU-PIN YANG, TAINAN (TW)

(73) Assignees: CHI-WEN GUO, TAINAN (TW); HSIN-CHIN CHEN, TAINAN (TW)

(21) Appl. No.: 12/771,181

(22) Filed: Apr. 30, 2010

(51) Int. Cl. F21L 4/00

(52) U.S. Cl. 362/157

(57) ABSTRACT

This invention relates to a luminous decoration strip which essentially comprises a main housing having a light emitting module disposed therein. The light emitting module includes a LED luminant, a control circuit and a power supply unit. A light guide sheet having reflecting stripes provided thereon is attached to the main housing such that the light emitted from the LED luminant is directed onto the reflecting stripes. The reflecting stripes reflect the light on both surfaces of the light guide sheet in such a manner that diversified luminous patters can be produced. In this way, the luminous decoration strip can be used in various fields, such as hand decoration, head ornaments, or diversified character patterns for advertising purpose etc.

### BACKGROUND OF THE INVENTION

1. Field of the Invention

The present invention relates to a luminous decoration strip, especially to a luminous means having diversified effect and function for application in alarming illumination, advertisement, indication or amusement, in which reflecting stripes are provided on light guide sheet so as to allow the light guide sheet to have pattern variations.

2. Brief Description of the Prior Art

Typical luminous device has widespread application in many fields. For example, it can be used as an alarming luminous device for pedestrian and jogger in the night, as an alarming luminous device for cyclist, or as an luminous means fixed on a certain part of a safety helmet, rear of a motorcycle, or lower end of a bicycle handlebar or saddle to show the function of displaying luminance or issuing alarm signal, or as an luminous device for eye-catching commercial advertisements. As most of its applications are displayed with short array of LEDs, not only much more quantity of LEDs has to be used but also bulky volume might be caused. Hence, this often leads to higher cost.

Another luminous device disclosed in Taiwanese Patent No. M361456 entitled “Luminous Alarm strip” comprises: a housing; a light emitting module in which a laser diode, a control circuit for controlling the light emitting state of the laser diode and battery unit for supplying power required for light emitting of the laser diode are disposed in the interior of the housing and a control switch of the control circuit is disposed on the exterior of the housing; a plastic optical fiber, the inner end face of which is closely abutted against the light output surface of the laser diode and is fixed on the housing such that the light beam produced by the laser diode is directed to the outside.

The application of the above structure is simply to have only the function of luminous alarm strip, and the plastic optical fiber is irradiated by the laser diode in such a manner that the light emitted by the strip is converged only at two sides of the plastic optical fiber to present as the form of light beam. Hence, its application range is quite limited.

In an effort to overcome the aforementioned deficiencies, the inventor of the present invention hereby proposes a luminous decoration strip based on his proficient experience and knowledge in R&D and manufacturing in relevant fields and endless endeavor, so as to achieve object of better practical value.

### SUMMARY OF INVENTION

The effect and object of the luminous decoration strip of the present invention is achieved by the following technology.

The luminous decoration strip of the present invention essentially comprises a main housing having a light emitting module disposed therein, the light emitting module including a LED luminant, a control circuit and a power supply unit, a light guide sheet having reflecting stripes provided thereon being attached to the main housing such that the light emitted from the LED luminant is directed onto the reflecting stripes, and the reflecting stripes reflecting the light on both sides of the light guide sheet in such a manner that diversified luminous patters can be produced. In this way, the luminous decoration strip can be used in various field such as hand decorations, head ornaments, or diversified character patterns for advertising purpose etc.

Moreover, the power supply unit of the light emitting module in the luminous decoration strip of the present invention can take advantage of a battery or solar photovoltaic equipment to supplying power.

Furthermore, the reflecting stripes provided on the light guide sheet in the luminous decoration strip of the present invention can be a concave-and-convex form (either straight or oblique lines) or formed as dots having reflecting effect. Moreover, the reflecting stripes can be formed as characters or patterns, or the characters or patterns without reflecting stripes can be formed while the residual part can be formed as the region having reflecting stripes. In this manner, diversified design and application of the light guide sheet can be achieved.

The main housing of the luminous decoration strip of the present invention is provided with a slit which is fitted with a corresponding snap-fit block provided on one end of the light guide sheet. In this manner, the light guide sheet can be combined with the main housing, and the light guide sheet is easily aligned with the LED illuminant. Moreover, the main housing can also has two oppositely arranged slits provided to cope with the type of light guide sheet having two snap-fit blocks provided on both ends thereof, so as to form a endless luminous decoration strip.

### BRIEF DESCRIPTION OF ACCOMPANYING DRAWINGS

FIG. 1 is a perspective schematic exploded view of the luminous decoration strip of the present invention.

FIG. 2 is a sectional schematic assembled view showing the luminous decoration strip of the present invention.

FIG. 3 is a schematic view showing the power supply of the present invention.

FIG. 4 is a first schematic view showing the light guide sheet of the present invention.

FIG. 5 is a second schematic view showing the light guide sheet of the present invention.

FIG. 6 is a third schematic view showing the light guide sheet of the present invention.

FIG. 7 is a schematic view of a first embodiment of the present invention.

FIG. 8 is a schematic view of a second embodiment of the present invention.

FIG. 9 is a schematic view of a third embodiment of the present invention.

FIG. 10 is a schematic view of a fourth embodiment of the present invention.

### DETAILED DESCRIPTION OF PREFERRED EMBODIMENTS

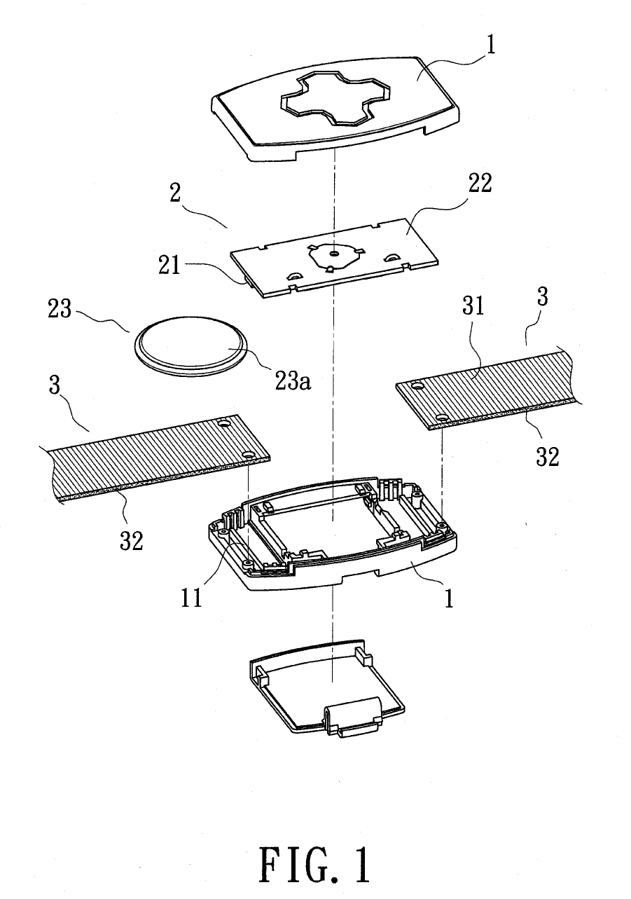

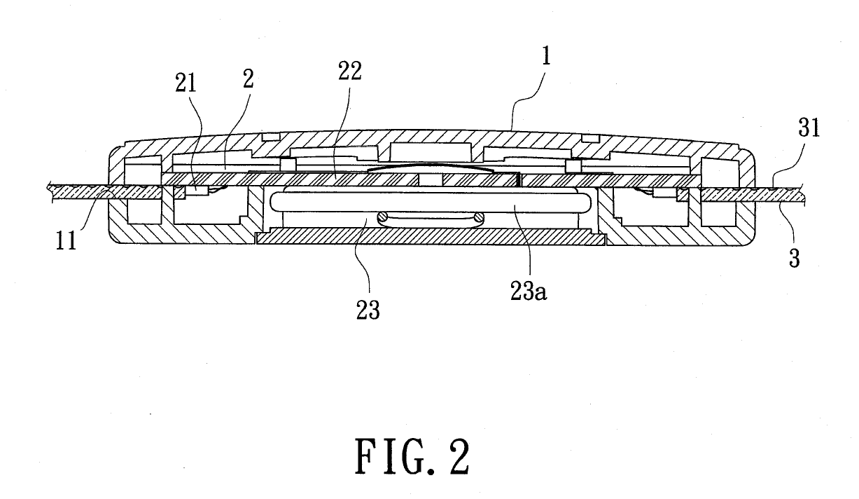

Firstly referring to FIGS. 1 to 2, the luminous decoration strip of the present invention comprises:

a main housing (1);

a light emitting module (2) disposed within the main housing (1), which has a LED luminant (21), a control circuit (22) and a power supply unit (23); and

a light guide sheet (3) which has reflecting stripes (31) on at least one surface thereof, the light guide sheet (3) being combined on the main housing (1) and opposite to the LED luminant (21) of the light emitting module (2). Moreover, shielding films (32) for preventing the light emitted out of the light emitting module (2) from scattering are respectively provided on both side edges of the light guide sheet (3) such that the light can be fully guided within the light guide sheet (3).

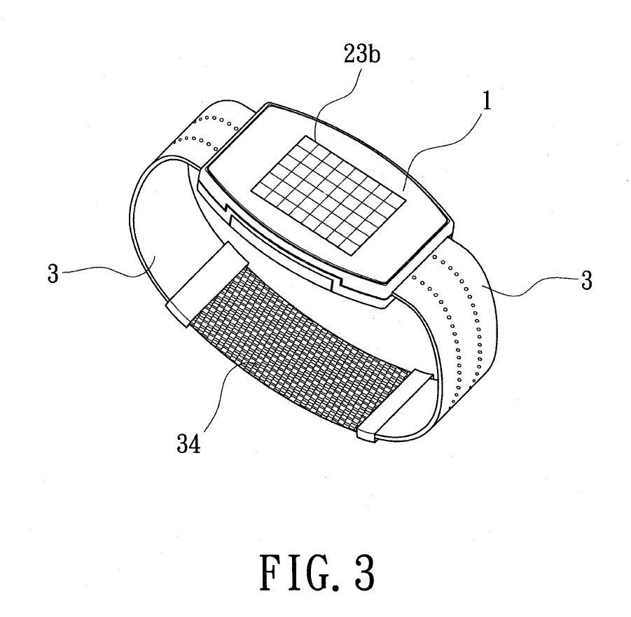

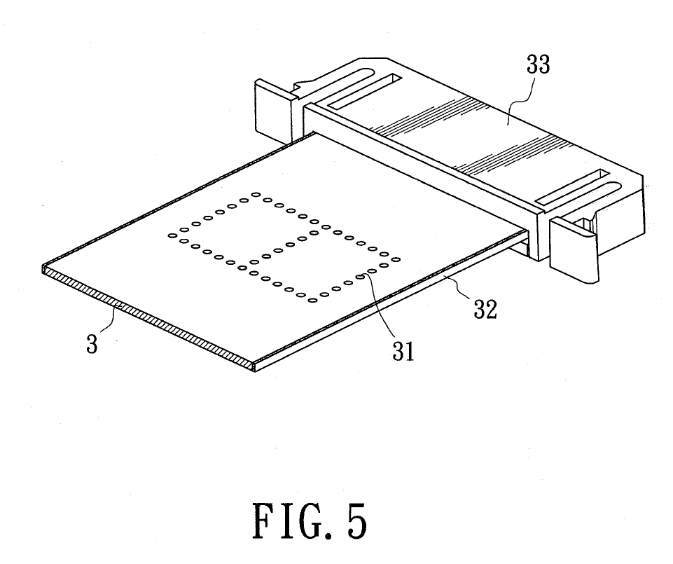

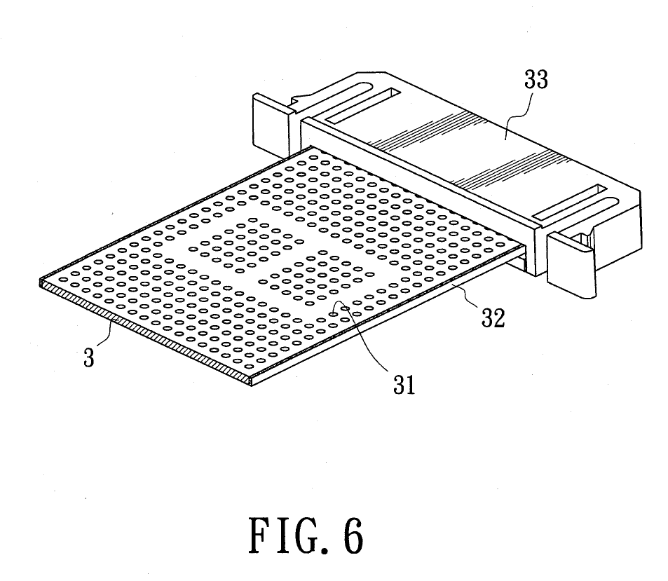

In assembly process, referring to FIGS. 1 to 10, the light emitting module (2) is provided within the main housing (1) and the light emitting module (2) is formed by the LED luminant (21), the control circuit (22) and the power supply unit (23), in which the number of the LED luminant (21) can be more than one. The control circuit (22) is used for controlling the luminous state of the LED luminant (21). The power supply unit (23) is used to supply power required for light emitting of the LED luminant (21) by means of a battery (23a) thereof or a solar photovoltaic equipment (23b) to supply electricity, as shown in FIG. 3.

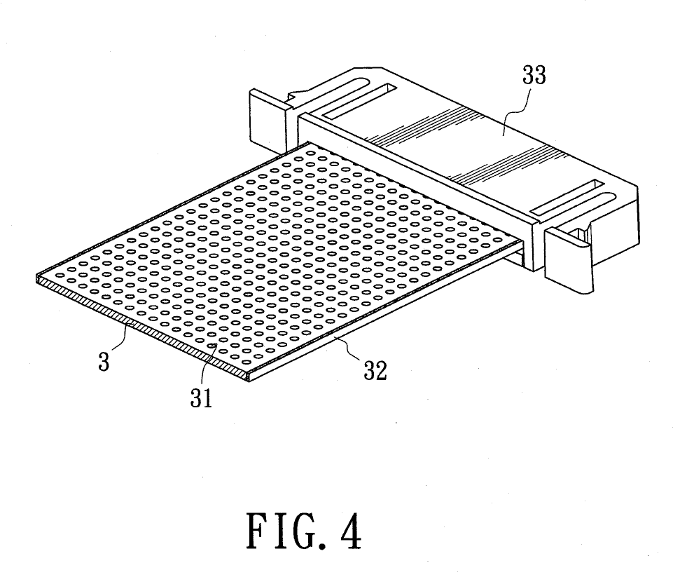

In turn, the light guide sheet (3) is attached to the main housing (1) and is opposite to the LED luminant (21). The attachment of the light guide sheet (3) to the main housing (1) is accomplished by the fitting between at least one slit (11) provided on the main housing (1) and at least one corresponding snap-fit blocks (33) provided on the light guide sheet (3). Further speaking, shielding films (32) are respectively provided on both side edges of the light guide sheet (3), so that the light emitted from the LED luminant (21) is not scattered out. The light emitted from the LED luminant (21) can be dispersed from both surfaces of the light guide sheet (3) by plating with material having reflecting action on both side edges of the light guide sheet (3) and by irradiating the light emitted from the LED luminant (21) onto the reflecting stripes (31) provided on the end face of the light guide sheet (3). The reflecting stripes (31) provided on the light guide sheet (3) can be a concave-and-convex form (either straight or oblique lines) or formed as dots having reflecting effect. Moreover, the reflecting stripes (31) can be formed as characters or patterns, such as words or catch-phrases for commercial advertisements, so that the characters or patterns can be highlighted by the irradiation of the LED luminant (21). Alternatively, the characters or patterns can be formed without reflecting stripes (31) while the residual part can be formed as the region having reflecting stripes (31). In this case, diversified designs and applications of the light guide sheet (3) can be achieved, as shown in FIGS. 4 to 6.

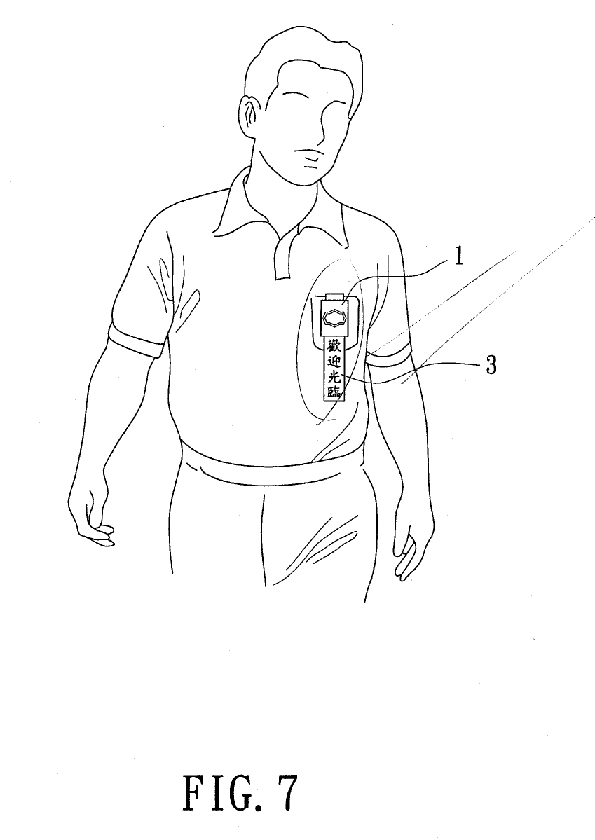

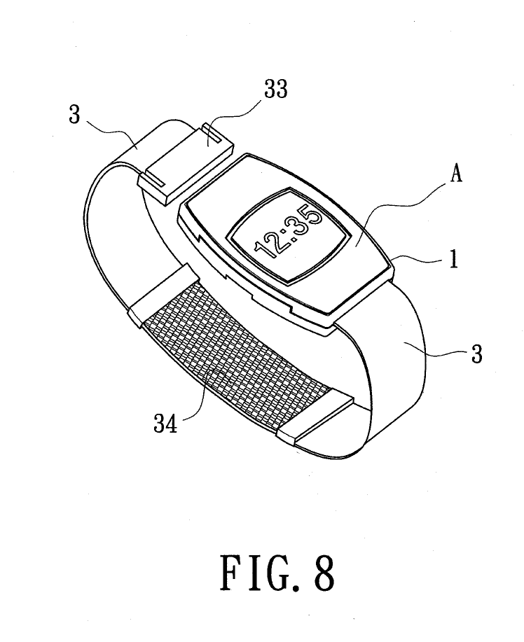

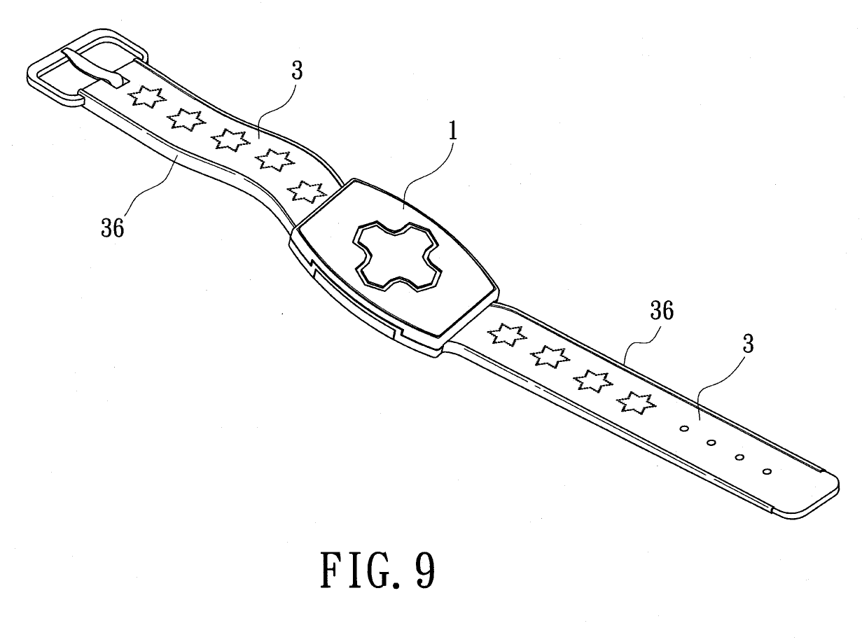

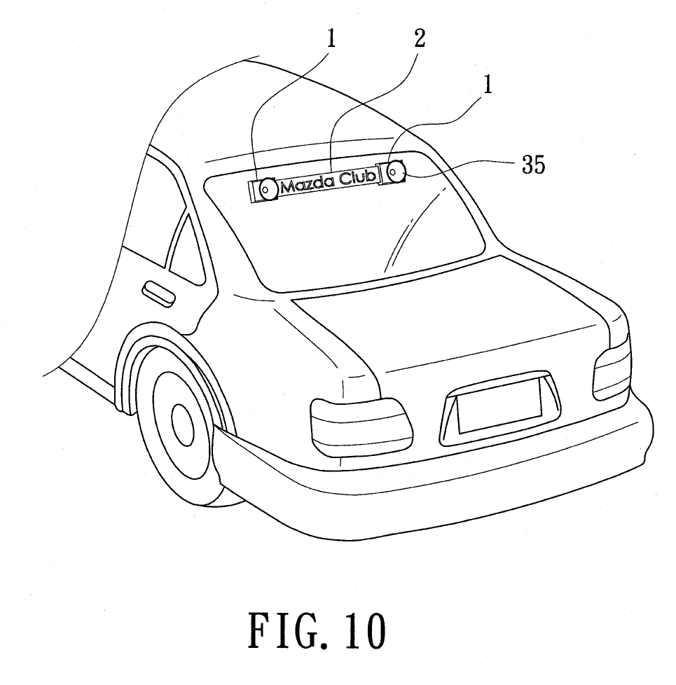

In addition, the integral embodiment of the present invention can be formed as a designation strip as shown in FIG. 7. Alternatively, two slits (11) arranged oppositely can be provided on the main housing (1) which are respectively fitted with snap-fit blocks (33) provided on both ends of the light guide sheet (3) so as to facilitate the combination between the main housing (1) and the light guide sheet (3) to form an endless luminous decoration strip. An additional elastic segment (34) can be added on the light guide sheet (3) so as to cope with various dimensions on wrist portion or head portion of different users, or the main housing (1) can be formed as a design of a wrist watch (A) so that the luminous decoration strip of the present invention can be embodied as a wrist watch as shown in FIG. 8. Both side edges of the light guide sheet (3) further can be provided with glue ornamental strips (36) having soft touch-feeling and sliding-proof effect, as shown in FIG. 9. Alternatively, a light guide sheet (3) is provided between two main housing (1) and an adhering element (35) is disposed on the outer surfaces of the two main housing (1) so that it can be adhered onto the windshield of a car. Then, characters or patterns can be arrayed by the reflecting stripes (31) of the light guide sheet (3) and the words, catch-phrases or patterns for commercial advertisements can be produced by irradiation from the light emitting module (2), as shown in FIG. 10.

It is understood from the above description, the present invention has the following advantages when comparing with conventional art.

1. The luminous decoration strip of the present invention can reflect and display the light emitted from the LED luminant by providing reflecting stripes on the light guide sheet so that it has advantages of sufficient luminance on lighting to achieve the purpose of alarming and eye-catching.

2. The reflecting stripes provided on the light guide sheet can have diversified variations to meet the demand for advertisement or indication and purpose for multi-function design.

What is claimed is:

1. A luminous decoration strip, comprising:
a main housing;
a light emitting module disposed within the main housing, which has a LED luminant, a control circuit and a power supply unit; and
a light guide sheet which has reflecting stripes provided on at least one surface thereof, the light guide sheet being combined on the main housing and being opposite to the LED luminant of the light emitting module.

2. The luminous decoration strip as claimed in claim 1, wherein shielding films for preventing the light emitted out of said light emitting module from scattering are provided on both side edges of said light guide sheet.

3. The luminous decoration strip as claimed in claim 1, wherein glue ornamental strips are provided on both side edges of said light guide sheet.

4. The luminous decoration strip as claimed in claim 1, wherein the reflecting stripes provided on said light guide sheet of said luminous decoration strip are in a concave-and-convex form.

5. The luminous decoration strip as claimed in claim 1, wherein the reflecting stripes provided on said light guide sheet of said luminous decoration strip are formed as dots.

6. The luminous decoration strip as claimed in claim 1, wherein a slit provided on said main housing is fitted by a snap-fit block provided on one end of said light guide sheet, such that said main housing is combined with said light guide sheet.

7. The luminous decoration strip as claimed in claim 6, wherein more than one slit is provided to fitted with corresponding at least one snap-fit block provided on said light guide sheet so as to facilitate the combination between said main housing and said light guide sheet.

8. The luminous decoration strip as claimed in claim 1, wherein said light guide sheet has an elastic segment.
